(19) United States
(12) Patent Application Publication
(10) Pub. No.: US 2026/0318617 A1
(43) Pub. Date: Oct. 15, 2026

(54) HEAT EXCHANGE DEVICE COMPRISING AT LEAST ONE MANIFOLD, AND AIR CONDITIONING SYSTEM AND VEHICLE

(71) Applicant: LIEBHERR-AEROSPACE TOULOUSE SAS, TOULOUSE (FR)

(72) Inventors: Florian BONNIVARD, Toulouse (FR); Romain ANGELIQUE, Toulouse (FR); Antoine LARAT, Toulouse (FR); Stéphane MEUNIER, Toulouse (FR); Grégoire HANSS, Toulouse (FR)

(73) Assignee: LIEBHERR-AEROSPACE TOULOUSE SAS, TOULOUSE (FR)

(21) Appl. No.: 19/491,367

(22) PCT Filed: Jun. 6, 2024
(86) PCT No.: PCT/EP2024/065564

§ 371 Date: Dec. 8, 2025

(30) Foreign Application Priority Data
Jun. 7, 2023 (FR) FR2305764

(51) Int. Cl. F28F 1/02; B64D 13/06; F28D 21/00; F28F 9/02

(52) U.S. Cl. CPC F28F 1/022; B64D 13/06; F28D 21/00; F28F 9/0275; B64D 2013/0603; F28D 2021/0021

(57) ABSTRACT

The invention relates to a heat-exchange device comprising: a heat-exchange matrix (50) housed in a flow enclosure and formed from a plurality of heat-exchange tubes, each tube comprising at least one conduit extending principally in a longitudinal direction, each conduit defining, at least in part, a flow channel for a second heat-transfer fluid,
at least one collector (20) comprising at least one conduit portion (22, 23, 24) extending principally in a plane orthogonal to said longitudinal direction, said collector comprising a plurality of orifices (30),
at least one fluid distribution duct (40) configured to enable the flow of a second heat-transfer fluid between at least one orifice of said collector and at least one conduit, each orifice of said collector opening towards a distribution duct.

The invention relates to an air-conditioning system and an aircraft comprising such a heat-exchange device.

### TECHNICAL FIELD OF THE INVENTION

The invention relates to a heat-exchange device, such as a heat exchanger for an aircraft or even a hydraulic cooling system, comprising at least one supply and/or outlet collector.

### TECHNOLOGICAL BACKGROUND

Heat exchangers are used to make possible a heat transfer between at least two liquid and/or gaseous fluids, in particular in order to cool or heat one of the fluids by means of another fluid. Heat exchangers are used in numerous contexts, in the cooling systems of electronic devices, for example, or even in air-conditioning systems for an air-borne, rail or land vehicle.

An environmental control system of a cabin of an aircraft, better known by the acronym ECS, is intended to supply the cabin of the aircraft (which generally designates any internal space of the aircraft where the pressure and/or temperature of the air must be controlled, such as a passenger cabin, the cockpit, a hold, etc.) with air at controlled pressure and/or temperature.

Most heat exchangers currently used on board aircraft are formed of heat exchangers of the type with fins or plates. These exchangers are formed from a heat-exchange chamber of a generally parallelepiped shape and comprise stacked layers of fins, for example corrugated fins which form flow channels between two plates and which extend in an alternating manner in perpendicular directions of one layer with respect to another. Thus, the hot pass, which supplies one face of the exchanger, flows in the channels of the different layers referred to as hot layers, and the cold pass, which supplies a perpendicular face of the exchanger, flows in the transverse channels of the layers referred to as cold layers interleaved between two hot layers. Such an architecture makes it possible to interleave each hot layer between two cold layers over the whole length of the exchanger and thus to ensure heat exchanges between the two fluids.

These heat exchangers make it possible to cool the air drawn from the engines or the ambient air compressed by dedicated compressors, before being processed by the other items of equipment of the air conditioning system in order to be able to supply the cabin of the aircraft. The cooling capacity of an exchanger is directly proportional to its size.

However, the size and mass of a heat exchanger are two features which are of critical importance for aircraft manufacturers, as in other applications, when seeking to achieve considerable cooling performance.

By way of an alternative to heat exchangers with plates integrated in atmospheric vehicles, WO 2020/109707 proposes a heat exchanger making it possible to increase exchange surfaces within the exchanger while limiting to the utmost degree the size of the exchanger by virtue of a matrix formed of heat-exchange tubes which is housed in a fluid flow chamber, each tube comprising at least one interior conduit and one exterior conduit which are nested one inside the other.

The inventors noted that there was no supply and/or outlet collector suitable for such a matrix formed of tubes being of satisfactory size and mass.

US 2018/0345425 describes a heat exchanger comprising a plurality of heat-exchange banks extending through a chamber of the heat-exchanger, each bank comprising a plurality of heat-exchange tubes. Collectors make possible a mutual fluid communication between the adjacent heat-exchange banks in the form of connection ports. Flow splitters are provided within inlet and outlet plenums.

The invention thus aims to propose a heat-exchange device making it possible to propose a solution adapted to the distribution of each fluid being inlet into and/or outlet from a heat exchanger comprising such tubes.

### Aims of the Invention

The invention aims to provide a heat-exchange device with an excellent level of efficacy in the distribution of the fluid.

The invention aims, in particular, to provide a heat-exchange device which is extremely compact, in particular being of limited size and mass.

The invention also aims to provide a heat-exchange device with an excellent level of efficacy.

### Description of the Invention

In order to achieve this, the invention relates to a heat-exchange device comprising:
a flow enclosure comprising a first inlet for a first heat-transfer fluid into the flow enclosure and a first outlet for said first heat-transfer fluid out of the flow enclosure,
a heat-exchange matrix housed in said flow enclosure and formed from a plurality of heat-exchange tubes, each heat-exchange tube comprising at least one conduit and extending principally in a longitudinal direction between two mutually opposing ends, each conduit defining, at least in part, a flow channel for a second heat-transfer fluid.
a second inlet for said second heat-transfer fluid into the flow enclosure,
a second outlet for said second heat-transfer fluid out of the flow enclosure, characterized in that it further comprises:
at least one collector comprising at least one conduit portion and comprising one of said second inlet of said second heat-transfer fluid and of said second outlet of said second heat-transfer fluid, said collector not extending parallel to said longitudinal direction of each heat-exchange tube, said collector comprising a plurality of orifices, each collector being configured to enable a flow of said second heat-transfer fluid between one of said second inlet for said second heat-transfer fluid and of said second outlet for said second heat-transfer fluid and said orifices,
at least one fluid distribution duct configured to enable the flow of said second heat-transfer fluid between at least one orifice of said collector and at least two heat-exchange tubes, each orifice of said collector opening towards a distribution duct, and at least one longitudinal end of each heat-exchange tube being connected to a distribution duct.

A heat-exchange device in accordance with the invention thus makes it possible to obtain a collection solution being inlet into and/or outlet from a heat-exchange matrix which is as compact as possible. This results in reduced size for the heat-exchange device. This thus makes possible numerous configurations for integration into an air-conditioning system, for example.

Thus, on the one hand, each collector connects one of said second inlet for said second heat-transfer fluid and of said second outlet for said second heat-transfer fluid and said orifices, and, on the other hand, each fluid distribution duct connects said collector and said at least two heat-exchange tubes of said heat-exchange matrix. Thus, advantageously and in accordance with the invention, said at least one collector connects in fluid communication one of said second inlet for said second heat-transfer fluid and of said second outlet for said second heat-transfer fluid and said at least one distribution duct. When considering the flow of said second fluid, each collector is thus disposed between said second inlet or said second outlet for said second heat-transfer fluid and at least one distribution duct for said second fluid, said second fluid being able to flow within each collector and each distribution duct.

The collector has the advantage of being able to make provision for the entry and/or exit of said second fluid laterally with respect to the heat-exchange matrix and not in its longitudinal extension. The collector, and thus each conduit portion thereof, does not extend in parallel (and without being merged) with the longitudinal direction of each heat-exchange tube. The collector can extend substantially within a plane orthogonal to said longitudinal direction or even in a manner not to be strictly contained within a plane, being of generally curved shapes and extending substantially principally in a plane forming a non-zero angle, for example less than 30°, with a plane orthogonal to said longitudinal direction of each heat-exchange tube. Advantageously and in accordance with the invention, said collector extends substantially principally in a plane orthogonal to said longitudinal direction of each heat-exchange tube.

Advantageously and in accordance with the invention, the heat-exchange device in accordance with the invention comprises:
a first passage, referred to as the passage for the first heat-transfer fluid, enabling the flow of a stream of the first heat-transfer fluid in the flow enclosure between the first inlet and the first outlet, and
a second passage, referred to as the passage for the second heat-transfer fluid, enabling the flow of a stream of the second heat-transfer fluid in the flow enclosure between the second inlet and the second outlet.

The combination in accordance with the invention of a collector comprising one or a plurality of conduit and distribution duct portions making possible the flow of the fluid from said conduit portion(s) of the collector to each conduit of the tubes of the heat-exchange matrix (or conversely from each conduit of the tubes of the heat-exchange matrix via said distribution ducts to the orifices of the collector in the case of an outlet collector). Thus, advantageously and in accordance with the invention, each conduit portion of said collector extends so as to surround, at least in part, said heat-exchange matrix. Each conduit portion of said collector can be of various shapes. Each conduit portion of said collector can be of a variable cross-section, in particular a cross-section decreasing from the fluid inlet to the interior of the collector.

Advantageously and in accordance with the invention, said heat-exchange matrix has a polygonal transverse cross-section. Advantageously and in accordance with the invention, said transverse cross-section of said heat-exchange matrix is of a quadrilateral shape.

In a particularly advantageous variant of a heat-exchange device in accordance with the invention, the collector extends facing at least three main faces of said heat-exchange matrix. Advantageously and in accordance with the invention, said collector extends so as to surround, without interruption, three of said four main faces of said heat-exchange matrix.

Advantageously and in accordance with the invention, each collector is generally of a U shape, or even a C shape. In particular, advantageously and in accordance with the invention, each free end of the arms of said U extends to an edge of a main face of said heat-exchange matrix.

Said collector being of a U shape is thus composed of three portions connected to each other by two bends. Advantageously and in accordance with the invention, said collector comprises a central conduit portion extending in a main direction between a first end and a second end, a first end of said main conduit portion being extended by a first lateral conduit portion and a second end of said main conduit portion being extended by a second lateral conduit portion, said first lateral conduit portion and said second lateral conduit portion each extending in a direction substantially orthogonal to the main direction of said central conduit portion.

Advantageously and in accordance with the invention, each central conduit portion of said collector comprises one of said second inlet for said second heat-transfer fluid and of said second outlet for said second heat-transfer fluid. In a particularly advantageous variant of a heat-exchange device in accordance with the invention, the central conduit portion of said collector comprises said second inlet for said second heat-transfer fluid.

The orifices of the collector opening towards the outlet ducts can be provided in any conduit portion of said collector. Advantageously and in accordance with the invention, said plurality of orifices of each collector is provided in said first lateral conduit and said second lateral conduit, said central conduit portion of the collector having no orifices.

There is also nothing to prevent provision being made, in the case of a heat-exchange matrix being in the form of a cylinder of revolution for example (the transverse cross-section of the heat-exchange matrix thus being circular), for the orifices to be distributed over the whole of a single conduit portion in the form of an arc of a circle.

Advantageously and in accordance with the invention, said collector extends so as to surround, without interruption, at least two thirds, in particular at least half (50%), or even at least 70%, of the perimeter of said heat-exchange matrix (measured in a plane orthogonal to said longitudinal direction of each heat-exchange tube of the heat-exchange matrix).

Since said collector extends, at least in part, around said heat-exchange matrix, it is possible to make provision for each distribution duct to connect said collector at two distinct points. Thus, in one advantageous embodiment in accordance with the invention, said heat-exchange device comprises a plurality of fluid distribution ducts, each fluid distribution duct extending between at least one orifice of said first lateral conduit of said collector and at least one orifice of said second lateral conduit of said collector.

Advantageously and in accordance with the invention, each fluid distribution duct extends principally in a direction orthogonal to said longitudinal direction of each heat-exchange tube of said heat-exchange matrix. In particular, said distribution ducts extend parallel to each other. Similarly, in particular, said distribution ducts extend principally in the same plane orthogonal to said longitudinal direction of each heat-exchange tube.

Advantageously and in accordance with the invention, each heat-exchange tube comprises at least one interior conduit and at least one exterior conduit which are nested one inside the other, so as to define:
a flow channel for a fluid, referred to as the interior channel, defined by said interior conduit, and adapted to be able to be supplied with said heat-transfer fluid,
a flow channel for a fluid, referred to as the intermediate channel, defined by the inter-conduit space between said interior conduit and said exterior conduit, and adapted to be able to be supplied with said second heat-transfer fluid.

Advantageously and in accordance with the invention, said heat-exchange matrix is adapted to enable the flow of a first stream of heat-transfer fluid in said flow enclosure in a direction, referred to as the main flow direction of the first fluid, between the first inlet and the first outlet.

A heat-exchange device in accordance with the invention can be a counter-current or even co-current (or parallel stream) device. Advantageously and in accordance with the invention, the course of the first stream of heat-transfer fluid and the course of the second stream of heat-transfer fluid within said flow enclosure can each be substantially straight. According to a particularly advantageous embodiment in accordance with the invention, said heat-exchange device is a counter-current device. The heat-exchange device in accordance with the invention is adapted to enable the flow of the second heat-transfer fluid in the passage for the second heat-transfer fluid, in a direction, referred to as the flow direction of the second fluid, substantially parallel to the main flow direction of the first fluid.

Of course, it is also possible to provide a heat-exchange device in which the stream of the one and/or the other of the first or of the second heat-transfer fluid follows a course within the heat-exchange matrix which is U-shaped or even S-shaped (referred to as multi-pass exchangers).

Advantageously and in accordance with the invention, the flow enclosure has a closed periphery which is sealed with respect to the heat-transfer fluids (at least in operation and without taking into account the inlets and outlets for the first heat-transfer fluid and for the second heat-transfer fluid).

Advantageously and in accordance with the invention, each heat-transfer fluid can be in the liquid or gaseous state. In particular, the state of the first heat-transfer fluid can be identical to, or different from, the state of the second heat-transfer fluid. Advantageously and in accordance with the invention, the heat-exchange device is configured so that the first heat-transfer fluid and the second heat-transfer fluid are in the gaseous state. Alternatively, advantageously and in accordance with the invention, the heat-exchange device is configured so that the first heat-transfer fluid is in the gaseous state and the second heat-transfer fluid is in the liquid state.

The second heat-transfer fluid can correspond to the fluid which is at a temperature higher than the temperature of the first heat-transfer fluid, or vice versa. Thus, advantageously and in accordance with the invention, the second heat-transfer fluid corresponds to the heat-transfer fluid which is at a temperature higher than the temperature of the first heat-transfer fluid. In other words, the first heat-transfer fluid can be designated “cold” fluid and the second heat-transfer fluid can be designated “hot” fluid.

Advantageously and in accordance with the invention, said heat-exchange device comprises a first collector, referred to as the inlet collector, and a second collector, referred to as the outlet collector. Advantageously and in accordance with the invention, said inlet collector comprises an inlet opening forming said second inlet for said second heat-transfer fluid in the flow enclosure. Advantageously and in accordance with the invention, said outlet collector comprises an outlet opening forming said second outlet for said second heat-transfer fluid out of the flow enclosure.

Said heat-exchange device in accordance with the invention can be formed from at least one material chosen from metallic materials, composite materials, polymeric materials, ceramic materials, in particular graphite, glass . . . In particular, in one particularly advantageous embodiment of a heat-exchange device in accordance with the invention, the conduits of the heat-exchange matrix are formed from a metallic material, in particular from at least one material chosen from the group formed by steels, copper, aluminum, metallic alloys (in particular super-alloys) and mixtures thereof.

The invention relates to an air-conditioning system comprising at least one heat-exchange device in accordance with the invention. It may in particular be a contactless, counter-current exchanger.

The invention relates to a vehicle, in particular an aircraft, comprising at least one air-conditioning system in accordance with the invention.

The invention also concerns a heat-exchange device, an air-conditioning system and a vehicle comprising at least one such air-conditioning system, which are characterized in combination by all or some of the features mentioned above or below.

### LIST OF FIGURES

Other aims, features and advantages of the invention will become apparent upon reading the following description given solely in a non-limiting way and which makes reference to the attached figures in which:

FIG. 1 is a schematic perspective view of a heat-exchange device in accordance with the invention,

FIG. 2 is a schematic perspective view of a part of a heat-exchange device in accordance with the invention, a part of which is a cross-sectional view,

FIG. 3 is a schematic cross-sectional view of a part of a collector and of distribution ducts of a heat-exchange device in accordance with the invention.

### DETAILED DESCRIPTION OF AN EMBODIMENT OF THE INVENTION

In the figures, for the purposes of illustration and clarity, scales and proportions have not been strictly respected.

Furthermore, identical, similar or analogous elements are designated by the same reference signs in all the figures.

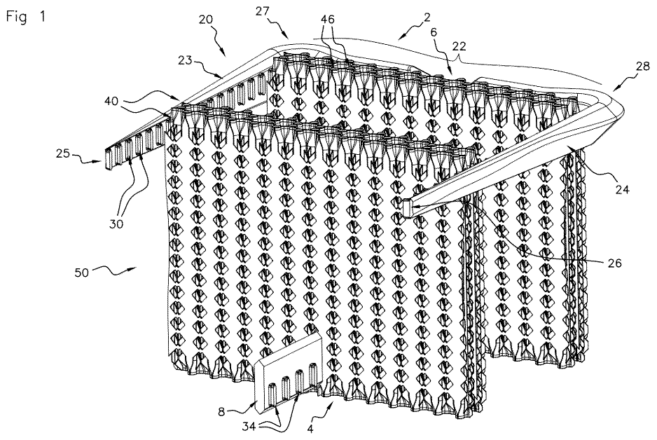

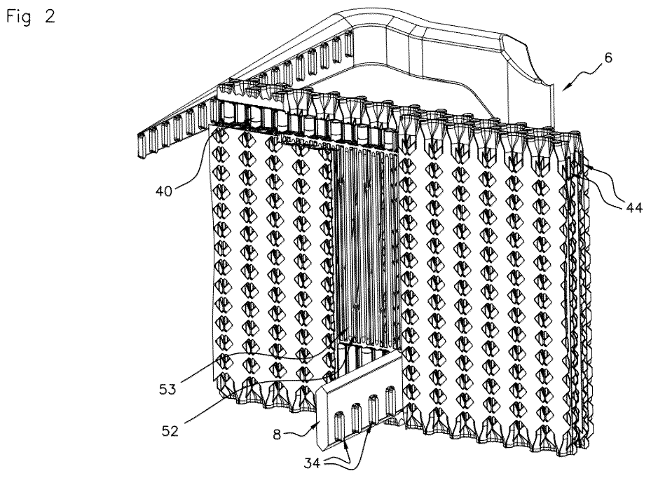

FIGS. 1 and 2 schematically illustrate a heat-exchange device in accordance with a first embodiment of the invention.

Such a heat-exchange device comprises a flow enclosure (not illustrated). The heat-exchange device comprises a first inlet 2 and a first outlet 4 for a first heat-transfer fluid in the flow enclosure, as well as a second inlet 6 and a second outlet 8 for a second heat-transfer fluid in the flow enclosure.

The heat-exchange device comprises a heat-exchange matrix 50 housed in the flow enclosure and formed from a plurality of heat-exchange tubes. Each heat-exchange tube comprises at least one conduit extending principally in a longitudinal direction between two mutually opposing ends. Each conduit defines, at least in part, a flow channel for a second heat-transfer fluid.

The heat-exchange matrix 50 thus makes possible the flow of the first heat-transfer fluid and of the second heat-transfer fluid in and through the flow enclosure and the transfer of calories therebetween.

The first heat-transfer fluid, referred to as the “cold” fluid, flows in regions of flow of the first heat-transfer fluid in a main flow direction of the first fluid between the first inlet 2 and the first outlet 4. The second heat-transfer fluid, referred to as the “hot” fluid, flows in regions of flow of the second heat-transfer fluid, which are distinct from the regions of flow of the first heat-transfer fluid, between the second inlet and the second outlet.

The heat-exchange matrix 50 is of a general shape having four main faces substantially parallel to said longitudinal direction. In the illustrated embodiment, the heat-exchange matrix is substantially of the general shape of a straight slab (contained within a straight slab). The transverse cross-section of the heat-exchange matrix 50 is thus of a rectangular shape, each collector 20 extending around the heat-exchange matrix 50 so as to surround three sides of said rectangle. In the illustrated embodiment, each collector 20 is generally of a U shape. There is nothing to prevent the provision of a heat-exchange matrix of a generally different shape, in particular a more complex shape, having outer lateral faces which are curved and/or even having a transverse cross-section (with respect to the longitudinal direction in which the heat-exchange tubes extend) which is close to an L shape or even a D shape depending on the space available for it to be integrated into. Moreover, a heat exchanger has the advantage of permitting numerous shapes, the collector and the distribution ducts consequently being able to be adapted thereto.

In the embodiment illustrated in FIGS. 1 to 3, each heat-exchange tube comprises an interior conduit 53 and an exterior conduit 52 nested one inside the other so as to define an interior channel, defined by the interior conduit, adapted to be able to be supplied with said first heat-transfer fluid, and an intermediate channel, defined by the inter-conduit space between said interior conduit 53 and said exterior conduit 52, adapted to be able to be supplied with the second heat-transfer fluid.

The heat-exchange device comprises a fluid collector 20. The collector 20 comprises the second inlet 6 of the second heat-transfer fluid. Each collector 20 extends substantially principally in a plane orthogonal to the longitudinal direction and surrounds, at least in part, three of said four main faces of the heat-exchange matrix 50. Each collector 20 comprises a plurality of orifices 30 enabling the passage of fluid. In the illustrated embodiment, each orifice 30 is of an oblong shape.

Each collector 20 comprises a central conduit portion 22 extending in a main direction between a first end 27 and a second end 28, a first lateral conduit portion 23 and a second lateral conduit portion 24. The first lateral conduit portion 23 and the second lateral conduit portion 24 each extend in a direction substantially orthogonal to the main direction of the central conduit portion 22. The collector thus extends forming a U from a first distal end 25 to a second distal end 26, the first lateral conduit portion 23 extending to the distal end 25 and the second lateral conduit portion 24 extending to the distal end 26. The collector 20 thus makes it possible to distribute the second heat-transfer fluid all around the heat-exchange matrix while being of minimal size and without hampering the flow of the first heat-transfer fluid which enters the spaces left free around the conduits 52 as well as via the openings 46 inside the interior conduits 53. Each conduit portion 22, 23, 24 of the collector 20 can have a variable cross-section and be of different shapes. Each conduit portion 22, 23, 24 of the collector can have a transverse cross-section with a variable surface area between the second inlet 6 for the second heat-transfer fluid or between their longitudinal ends. As shown in FIGS. 1 and 2, this is the case in the illustrated embodiment. In particular, the transverse cross-section of the first lateral conduit portion 23 decreases progressively between the first end 27 of the central conduit portion 22 and the distal end 25. Similarly, the transverse cross-section of the second lateral conduit portion 24 also decreases progressively between the second end 28 of the central conduit portion 22 and the distal end 26. On the other hand, in the illustrated embodiment, each conduit portion 22, 23, 24 of the collector 20 has a substantially oblong and/or substantially rectangular transverse cross-section.

However, there is nothing to prevent provision being made for the collector and each conduit portion thereof to extend in some other way than strictly orthogonally to the longitudinal direction of each heat-exchange tube. The collector could extend substantially in a plane forming a non-zero angle, for example less than 30°, with a plane orthogonal to the longitudinal direction of each heat-exchange tube. This makes it possible to adapt to various desired shapes and in particular to the space constraints so as to optimize the space occupied. In any case, each collector has the advantage of being able to be configured to allow lateral entry and/or exit of the second fluid and for this not to be in the longitudinal extension of the heat-exchange matrix.

The heat-exchange device comprises a plurality of fluid distribution ducts 40 configured to enable the flow of the second heat-transfer fluid between at least one orifice 30 of the collector 20 and at least one conduit 52 of the plurality of heat-exchange tubes. Each orifice 30 of the collector opens towards a distribution duct 40. In the illustrated embodiment, each fluid distribution duct 40 extends between an orifice 30 of the first lateral conduit portion 23 of the collector and an orifice of the second lateral conduit portion 24 of the collector. The central conduit portion 22 of the collector has no orifices 30, the orifices being provided in this case only in the first lateral conduit 23 and the second lateral conduit 24 of the collector 20. FIG. 2 shows that a part of the distribution duct 40 visible in the first plane of the heat-exchange matrix 50 is illustrated in a broken-away manner in which the walls of the conduits 52 have been removed for the purposes of illustration. Similarly, in FIG. 2, a part of the tubes is shown in longitudinal cross-section so as to enable the interior channels and the intermediate channels of the exterior conduits 52 and interior conduits 53 to be seen. Each heat-exchange tube thus has a longitudinal end connected to a distribution duct 40. The distribution ducts 40 extend parallel to each other and in the same plane orthogonal to the longitudinal direction of each heat-exchange tube.

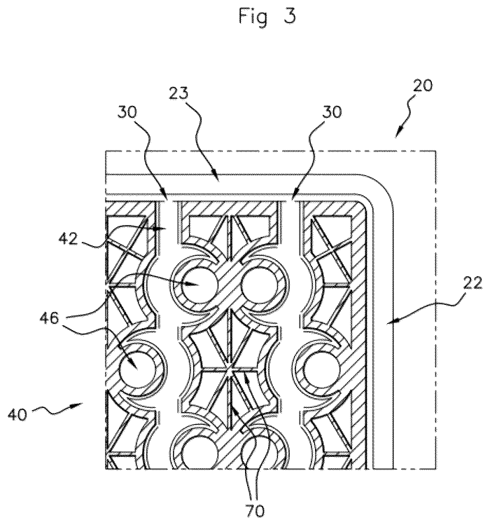

FIG. 3 schematically illustrates a cross-sectional view of a portion of the collector 20 and a portion of two distribution ducts 40 of the heat-exchange device. More precisely, the detail illustrated in FIG. 3 shows a portion of the first lateral conduit 23 and of the central conduit portion 22 of the collector 20. Two orifices 30 provided within the first lateral conduit portion 23 can be seen, each connected to a distribution duct 40, each distribution duct 40 comprising a channel 42 connecting to a plurality of conduits 52. Each distribution duct 40 has openings 44 having substantially the same dimensions as the dimensions of each orifice 30 of the collector, facing which it is positioned. FIG. 3 also shows reinforcements 70 making it possible to improve the stiffness of the distribution ducts 40. In the illustrated embodiment, all of the distribution ducts 40 of the heat-exchange device are formed as a single piece (for example by three-dimensional printing (or additive manufacture) or even by molding).

In the illustrated embodiment, at the outlet (lower part of the heat-exchange matrix 50 in FIGS. 1 and 2), the second heat-transfer fluid is evacuated out of all the conduits 52 via a central arm comprising the second outlet 8. However, there is nothing to prevent the provision, at the outlet, of an outlet collector identical to the inlet collector 20. There is also nothing to prevent provision being made for the second outlet not to be disposed substantially in the center of the heat-exchange matrix 50 but offset to a greater or lesser degree towards an edge of the heat-exchange matrix 50 depending on the desired configuration.

As shown in FIGS. 1 and 2, the second outlet 8 is not disposed on the same side of the heat-exchange matrix as the second inlet 6 but diametrically opposite thereto (without being disposed in the same plane). This makes it possible to promote the distribution and dispersion of the second heat-transfer fluid in all of the heat-exchange tubes of the heat-exchange matrix 50. Thus, in the illustrated embodiment, the fluid inlet 6 of the collector 20 and the second outlet 8 of the central arm are configured so as to be disposed on two mutually distinct and mutually parallel faces of the four main faces of the heat-exchange matrix which are substantially parallel in said longitudinal direction.

Furthermore, each collector 20 can be connected to an entry or evacuation conduit for the first heat-transfer fluid or the second heat-transfer fluid.

A heat-exchange device in accordance with the invention thus effectively makes it possible efficiently to distribute a fluid in a heat-exchange matrix 50 comprising conduits while being of small size. The configuration of each collector 20 of a heat-exchange device in accordance with the invention

1. A heat-exchange device comprising:
a flow enclosure comprising a first inlet for a first heat-transfer fluid into the flow enclosure and a first outlet for said first heat-transfer fluid out of the flow enclosure,
a heat-exchange matrix housed in said flow enclosure and formed from a plurality of heat-exchange tubes, each heat-exchange tube comprising at least one conduit and extending principally in a longitudinal direction between two mutually opposing ends, each conduit defining, at least in part, a flow channel for a second heat-transfer fluid,
a second inlet for said second heat-transfer fluid into the flow enclosure,
a second outlet for said second heat-transfer fluid out of the flow enclosure,
at least one collector comprising at least one conduit portion and comprising one of said second inlet for said second heat-transfer fluid and of said second outlet for said second heat-transfer fluid, said collector not extending parallel to said longitudinal direction of each heat-exchange tube of said heat-exchange matrix, said collector comprising a plurality of orifices each collector being configured to enable a flow of said second heat-transfer fluid between one of said second inlet for said second heat-transfer fluid and of said second outlet for said second heat-transfer fluid and said orifices,
at least one fluid distribution duct configured to enable the flow of said second heat-transfer fluid between at least one orifice of said collector and at least two heat-exchange tubes, each orifice of said collector opening towards a distribution duct, and at least one longitudinal end of each heat-exchange tube being connected to a distribution duct.

2. The device as claimed in claim 1, wherein each conduit portion of said collector extends so as to surround, at least in part, said heat-exchange matrix.

3. The device as claimed in claim 1, wherein said collector extends substantially principally in a plane orthogonal to said longitudinal direction of each heat-exchange tube.

4. The device as claimed in claim 1, wherein each collector generally of a U shape.

5. The device as claimed in claim 1, wherein each collector comprises a central conduit portion extending in a main direction between a first end and a second end, said first end of said main conduit portion being extended by a first lateral conduit portion and said second end of said main conduit portion being extended by a second lateral conduit portion, said first lateral conduit portion and said second lateral conduit portion each extending in a direction substantially orthogonal to said main direction of said central conduit portion.

6. The device as claimed in claim 5, wherein said central conduit portion of said collector comprises said second inlet of said second heat-transfer fluid.

7. The device as claimed in claim 5, wherein said plurality of orifices of each collector is provided in said first lateral conduit and said second lateral conduit, said central conduit portion of the collector having no orifices.

8. The device as claimed in claim 5, wherein it comprises a plurality of fluid distribution ducts, each fluid distribution duct extending between at least one orifice of said first lateral conduit of said collector and at least one orifice of said second lateral conduit of said collector.

9. The device as claimed in claim 1, wherein each fluid distribution duct extends principally in a direction orthogonal to said longitudinal direction of each heat-exchange tube of said heat-exchange matrix.

10. The device as claimed in claim 1, wherein each heat-exchange tube comprises at least one interior conduit and at least one exterior conduit which are nested one inside the other so as to define:
a flow channel for a fluid, referred to as the interior channel, defined by said interior conduit, and adapted to be able to be supplied with said heat-transfer fluid,
a flow channel for a fluid, referred to as the intermediate channel, defined by the inter-conduit space between said interior conduit and said exterior conduit, and adapted to be able to be supplied with said second heat-transfer fluid.

11. An air-conditioning system comprising at least one heat-exchange device comprising a flow enclosure comprising a first inlet for a first heat-transfer fluid into the flow enclosure and a first outlet for said first heat-transfer fluid out of the flow enclosure,
a heat-exchange matrix housed in said flow enclosure and formed from a plurality of heat-exchange tubes, each heat-exchange tube comprising at least one conduit and extending principally in a longitudinal direction between two mutually opposing ends, each conduit defining, at least in part. a flow channel for a second heat-transfer fluid,
a second inlet for said second heat-transfer fluid into the flow enclosure.
a second outlet for said second heat-transfer fluid out of the flow enclosure,
at least one collector comprising at least one conduit portion and comprising one of said second inlet for said second heat-transfer fluid and of said second outlet for said second heat-transfer fluid, said collector not extending parallel to said longitudinal direction of each heat-exchange tube of said heat-exchange matrix, said collector comprising a plurality of orifices, each collector being configured to enable a flow of said second heat-transfer fluid between one of said second inlet for said second heat-transfer fluid and of said second outlet for said second heat-transfer fluid and said orifices,
at least one fluid distribution duct configured to enable the flow of said second heat-transfer fluid between at least one orifice of said collector and at least two heat-exchange tubes, each orifice of said collector opening towards a distribution duct, and at least one longitudinal end of each heat-exchange tube being connected to a distribution duct.

12. A vehicle comprising an aircraft comprising at least one air-conditioning system comprising at least one heat-exchange device comprising a flow enclosure comprising a first inlet for a first heat-transfer fluid into the flow enclosure and a first outlet for said first heat-transfer fluid out of the flow enclosure,
a heat-exchange matrix housed in said flow enclosure and formed from a plurality of heat-exchange tubes, each heat-exchange tube comprising at least one conduit and extending principally in a longitudinal direction between two mutually opposing ends, each conduit defining, at least in part. a flow channel for a second heat-transfer fluid,
a second inlet for said second heat-transfer fluid into the flow enclosure,
a second outlet for said second heat-transfer fluid out of the flow enclosure,
at least one collector comprising at least one conduit portion and comprising one of said second inlet for said second heat-transfer fluid and of said second outlet for said second heat-transfer fluid, said collector not extending parallel to said longitudinal direction of each heat-exchange tube of said heat-exchange matrix, said collector comprising a plurality of orifices, each collector being configured to enable a flow of said second heat-transfer fluid between one of said second inlet for said second heat-transfer fluid and of said second outlet for said second heat-transfer fluid and said orifices,
at least one fluid distribution duct configured to enable the flow of said second heat-transfer fluid between at least one orifice of said collector and at least two heat-exchange tubes, each orifice of said collector opening towards a distribution duct, and at least one longitudinal end of each heat-exchange tube being connected to a distribution duct.
